(19) United States
(12) Patent Application Publication
(10) Pub. No.: US 2012/0129115 A1
(43) Pub. Date: May 24, 2012

(54) METHOD FOR CHANGING THE DIRECTION OF MAGNETIZATION IN FERROMAGNETIC LAYER

(76) Inventors: Massimiliano Marangolo, Paris (FR); Maurizio Sacchi, Paris (FR)

(21) Appl. No.: 13/377,605

(22) PCT Filed: Jun. 22, 2010
(86) PCT No.: PCT/FR10/51274

§ 371 Date: Feb. 9, 2012

(30) Foreign Application Priority Data
Jun. 29, 2009 (FR) 0954403

(51) Int. Cl. F27D 99/00

(52) U.S. Cl. 432/1

(57) ABSTRACT

The invention provides a method of modifying the direction of magnetization of an upper layer (2) comprising a ferromagnetic material, the method being characterized by: a) placing the upper layer (2) above a lower layer (3) that is not magnetically coupled with the upper layer (2), the lower layer (3) comprising a material suitable for acting or not acting, depending on whether the temperature of said material is greater than or less than a threshold value, to produce a radiated magnetic field suitable for modifying the direction of magnetization or the upper layer (2), the magnetic field radiated by the material of the lower layer (3) being greater than the coercive field of the ferromagnetic material of the upper layer (2); and in that the method comprises: b) a step consisting in causing the temperature of the lower layer (3) to pass from a first value in which the directions of magnetization of the upper layer (2) and of the lower layer (3) are in a stable relative configuration and in which the material of the lower layer (3) does not produce a radiated magnetic field, to a second value in which the material of the lower layer (3) produces a radiated magnetic field suitable for modifying the direction of magnetization of the upper layer (2) in irreversible manner; and c) a step consisting in causing the temperature of the lower layer (3) to pass from the second value to a third value in which the material of the lower layer (3) does not produce a radiated magnetic field; the temperature variation steps b) and c) being performed without applying an external magnetic field.

The present invention provides a method of modifying the direction of magnetization of a layer of ferromagnetic material. The method makes it possible to control the direction of magnetization locally in the absence of an external magnetic field.

In magnetic recording devices, it is particularly important to be able to control the direction of magnetization of a magnetic strip locally.

For this purpose, it is known to apply a magnetic field locally using a magnetic coil. Such a device presents the drawback of being slow, since it presents a certain amount of inertia. In addition, the method requires magnetic fields to be applied of ever greater intensity as the size of the magnetic items decreases, thus leading to the use of a coil that is large in size, and not very compatible with accurately controlling the direction of magnetization of a strip portion of small dimensions.

The invention seeks to remedy those drawbacks.

In particular, the invention provides a method that makes it possible to modify locally the direction of magnetization of a layer of ferromagnetic material, and in particular to reverse it locally, in the absence of an external magnetic field.

The invention thus provides a method of modifying the direction of magnetization of an upper layer comprising a ferromagnetic material.

In accordance with the method of the invention:

a) the upper layer is placed above a lower layer that is not magnetically coupled with the upper layer, the lower layer comprising a material suitable for acting or not acting, depending on whether the temperature of said material is greater than or less than a threshold value, to produce a radiated magnetic field suitable for modifying the direction of magnetization of the upper layer, the magnetic field radiated by the material of the lower layer being greater than the coercive field of the ferromagnetic material of the upper layer.

The method further comprises:

b) a step consisting in causing the temperature of the lower layer to pass from a first value in which the directions of magnetization of the upper layer and of the lower layer are in a stable relative configuration and in which the material of the lower layer does not produce a radiated magnetic field, to a second value in which the material of the lower layer produces a radiated magnetic field suitable for modifying the direction of magnetization of the upper layer in irreversible manner; and

c) a step consisting in causing the temperature of the lower layer to pass from the second value to a third value in which the material of the lower layer does not produce a radiated magnetic field.

The temperature variation steps b) and c) are performed without applying an external magnetic field.

The lower layer and the upper layer are “not magnetically coupled” in the meaning of the invention, i.e. the magnetic coupling between the lower layer and the upper layer is weak enough for the directions of magnetization of the upper layer and of the lower layer initially to be in a first stable relative configuration and for them to be in a second stable relative configuration at the end of the method.

At the second temperature value, the material of the lower layer produces a radiated magnetic field suitable for modifying the direction of magnetization of the upper layer in “irreversible” manner. This term is used to mean that during the temperature variation of step c), the modification to the direction of magnetization in the upper layer is conserved in stable manner. Thus, a new stable configuration is obtained for the relative magnetic alignment of the lower and upper layers.

The method makes use of the ability of the material of the lower layer to produce a radiated magnetic field above or below a threshold temperature. It is thus possible to modify the direction of magnetization of the upper layer by varying temperature.

Typically, the material of the lower layer is capable of producing a radiated magnetic field suitable for modifying the direction of magnetization of the upper layer when the temperature of said material is higher than a threshold value. Thus, if the temperature of the lower layer is lower than the threshold value, it is possible to stabilize at least two magnetic alignment configurations between the lower layer and the upper layer.

In an implementation, depending on whether the temperature of the material of the lower layer is lower than or higher than a threshold value, the lower layer may present a uniform structure that is entirely ferromagnetic or a non-uniform structure comprising an alternation of zones that are ferromagnetic and non-ferromagnetic.

It is the presence of non-ferromagnetic zones that gives rise to a radiated field being produced by the ferromagnetic zones from the lower layer towards the upper layer, thereby causing the modification to the direction of magnetization of the upper layer.

In particular, the material of the lower layer may present a uniform structure when the temperature of the material is lower than a threshold temperature, and it may present a non-uniform structure when the temperature of the material is higher than a threshold temperature.

By way of example, the lower layer may be a layer of MnAs formed by epitaxy on a GaAs substrate, in particular a substrate having the GaAs (001) structure.

It is also possible to envisage that the non-uniform structure of the lower layer is obtained by implanting ions in the lower layer, e.g. by implanting rare gas ions. Implanting ions serves to modify the Curie temperature of the implanted zone. The Curie temperature is the temperature beyond which a material loses its spontaneous magnetization. After implantation, the lower layer is characterized by an alternation of ferromagnetic zones having Curie temperatures T1 and T2 respectively. The threshold temperature is selected to lie between T1 and T2 so as to have an alternation of ferromagnetic zones and non-ferromagnetic zones.

The lower layer that may be subjected to such ion implantation may for example be a layer of FePd, FeNi, NiMn, FeGa, or FePt alloy.

By way of example, the upper layer may be a layer of Fe, Ni, Co, or of a ferromagnetic alloy including at least one of these elements, e.g. a permalloy alloy (NiFe).

In order to encourage non-magnetic coupling between the lower layer and the upper layer, a layer of non-ferromagnetic material may be arranged between the lower layer and the upper layer. It should be noted that when use is made of a layer of MnAs formed by epitaxy on a GaAs substrate, then a very fine layer of interface alloy is observed to be formed, thereby serving to limit coupling between the lower layer and the upper layer, without it being necessary to place an additional layer between the lower layer and the upper layer.

The magnetic field radiated by the material of the lower layer is greater than the coercive field of the ferromagnetic material of the upper layer, so as to facilitate modifying the direction of magnetization of the upper layer.

Other characteristics and advantages of the present invention appear more clearly on reading the following description given by way of non-limiting illustrative example and made with reference to the accompanying drawings, in which:

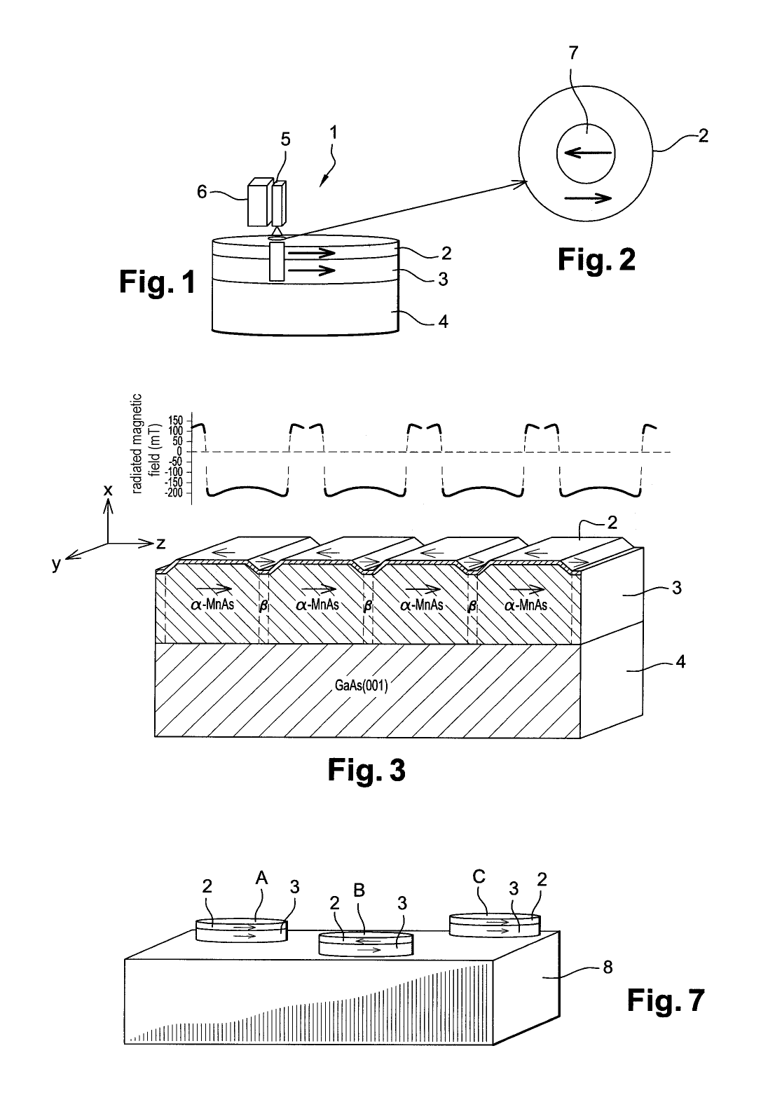

FIG. 1 is a diagram of a device for implementing the method of the invention;

FIG. 2 is a detailed plan view of the device;

FIG. 3 is a fragmentary view of the device while performing the method;

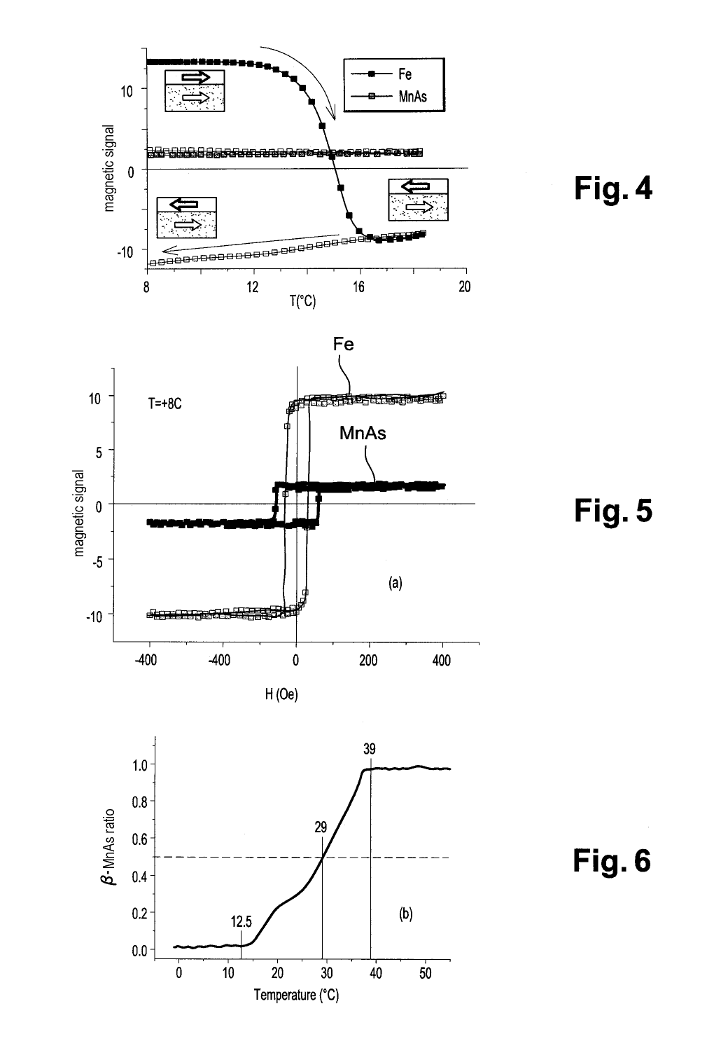

FIGS. 4 to 6 are diagrams of use in understanding the method; and

FIG. 7 is a diagram of a particular device for implementing the method of the invention.

As shown in FIG. 1, the device 1 comprises an upper layer 2 of ferromagnetic material placed on a lower layer 3 of ferromagnetic material, itself placed on a substrate 4. The matrix constituted by the upper and lower layers 2 and 3 together with the substrate 4 may be in the form of a disk.

The device 1 also includes a heater element 5 and a magnetic read head 6.

The heater element 5 locally heats the lower layer 3. Local heating serves no modify locally the structure of the matrix, thereby giving rise to radiated bipolar magnetic fields being formed, also referred to as leakage flux, within the upper layer 2. The direction of magnetization of the upper layer 2 is locally modified, by being reversed in the example shown in FIG. 1, in a one 7 that is heated by the heater element 5, as shown in FIG. 2. The temperature of the matrix is then lowered to its initial value. The new magnetic alignment is stable. The read head 6 monitors the local magnetic state in the upper layer 2.

An example of the device is shown in greater detail in FIG. 3. The device is prepared by molecular beam epitaxy. An upper layer 2 of Fe having a thickness of 5 nanometers (nm) is deposited on the top surface of a lower layer 3 of MnAs having a thickness of 140 nm. The lower layer 3 is obtained by epitaxial growth on a substrate 4 of GaAs (001).

MnAs possesses good compatibility with semiconductor substrates and with high-spin polarization. At ambient temperature, more precisely in the range 13° C. to 40° C., MnAs/GaAs presents a self-organized strip structure with. alternating α-MnAs ferromagnetic phases and β-MnAs non-ferromagnetic phases. The period of these strips, i.e. the sum of the width of an α-MnAs plus the width of a β-MnAs strip is determined by the thickness of the layer 3 of MnAs. The period is substantially constant as a function of temperature and is equal to about five times the thickness of the layer 3 of MnAs.

In the temperature range 13° C. to 40° C., within which the α-MnAs and β-MnAs phases coexist, the width of the β-MnAs strip increases with increasing temperature. There exists a difference in height. between the α-MnAs phases (which appear in the form of ridges) and the β-MnAs phases, which appear in the form of furrows between the α-MnAs phases. The difference in height between the α-MnAs and β-MnAs phases is of the order of 2% of the thickness of the layer of MnAs, i.e. only a few nm. The magnetic field radiated by the lower layer 3 orients the magnetization of the upper layer 2 of Fe.

The radiated magnetic field (in milliteslas (mT) produced in the upper layer 2 is shown in the upper portion of FIG. 3.

In order to encourage control, over the direction of magnetization of the layer 2 of Fe, it is possible to reduce the coercive field of the layer 2 of Fe, e.g. by using an alloy having a weaker coercive field, such as for example an FeNi alloy or an FeNiB alloy.

Thus, the configuration in which the magnetization in the upper layer 2 of Fe and the magnetization in the lower layer 3 of MnAs have the same direction at low temperature is modified in the presence of furrows of β-MnAs, without it being necessary to apply an external magnetic field.

FIG. 4 is a diagram showing the magnetization of the upper layer and of the lower layer as a function of temperature. The magnetic behavior of the sample is observed by X-ray resonant magnetic scattering (XRMS), using circularly-polarized X-rays. By adjusting the photon energy to the Mn-2p resonance (about 640 electron volts (eV)) or to the Fe-2p resonance (about 707 eV) , the specular reflective intensity is sensitive to the magnetization of the MnAs layer or of the Fe layer, respectively. Data is collected in a coplanar configuration, the strip being oriented orthogonally to the diffusion plane. The angle of diffusion is set to 16°. The sample carrier is integrated with a Peltier device in order to control temperature over the range −10° C. to +80° C., and also with an electromagnet (up to 1.5 kilo-oersted (kOe) at the sample).

For a given resonance, the asymmetry ratio is proportional to the magnetic moment of the element. The magnetic signal (asymmetry ratio) of Fe is represented by the curve beginning at the top in FIG. 4 and terminating at the bottom in FIG. 4, while the magnetic signal (asymmetry ratio) of MnAs is represented by the substantially horizontal curve situated in the middle of FIG. 4. After applying a 1 kOe magnetic pulse at 8° C., the temperature of the sample is taken from 8° C. to 18° C. (solid squares) and then from 18° C. to 8° C. (hollow squares), without applying a magnetic field.

FIG. 5 shows the hysteresis cycles of Fe and MnAs at 8° C., representing the magnetization of Fe and of MnAs as a function of the applied magnetic field. The magnetic pulse prepares the initial state of the thermal cycle with a direction of magnetization that is identical for the Fe layer and for the MnAs layer. It should be observed that the coupling between the two layers is weak, since the coercive fields of the two layers are very different.

With reference once more to FIG. 4, the method begins at 8° C. with an identical direction of magnetization for the Fe layer and for the MnAs layer. When the temperature increases, the magnetization of the Fe layer remains substantially constant until the β-MnAs phase appears at about 13° C. This is confirmed by observing the variation in the β-MnAs ratio in the MnAs as a function of temperature, as shown in FIG. 6. In the range 13° C. to 16° C., the magnetization of the Fe decreases rapidly and then reverses. Above 16° C., the zones of β-MnAs are wide enough to give rise to irreversible modification of the direction of magnetition. Thus, when the temperature is subsequently taken down to the initial value of 8° C., the magnetization of the Fe layer remains in the direction opposite to that of the MnAs layer, even though the temperature is identical to what it was at the beginning of the method and the method has been performed with zero applied magnetic field.

Thus, a small adjustment of the MnAs/GaAs microstructure by temperature control enables the magnetization direction of the Fe layer to be reversed completely without applying a magnetic field. The reversal of magnetization may be obtained locally by using focused-laser radiation. Thus, a structural variation equivalent to a temperature rise of 5° C. can be obtained by irradiation with a laser pulse. By way of example, it is possible to use laser pulses at a wavelength λ=400 nm, having a duration of 10⁻¹³ seconds (s), and with each pulse presenting an energy density of about 100 microjoules per square millimeter (μJ/mm²). The structural variation takes place on a time scale of about 10⁻¹¹ s.

FIG. 7 shows a particular application of the method of the invention, referred to as a “temperature indicator”. A plurality of assemblies A, B, and C, each constituted by an upper layer 2 of Fe and a lower layer 3 of MnAs, as described above, are placed on a substrate 8. Using a magnetization detector (not shown) e.g. such as a sensor making use of the Kerr effect, it is detected whether the magnetization of the layers 2, 3 is in a parallel configuration (as applies to the assemblies A and B) or antiparallel (as applies to the assembly B). If the configuration is antiparallel, then it is deduced that the local temperature of the substrate 8 exceeds or has exceeded the threshold temperature beyond which the magnetization of the upper layer 2 reverses.

The method of the invention thus presents numerous advantages. The modification in the direction of magnetization of the upper layer is controlled solely by temperature. There is no need to apply a magnetic field by means of a coil or an external magnet. The direction of magnetization is modified over a small temperature difference, and therefore requires little energy. The local heating takes place over a duration that is very short and may be of the order of 10⁻¹¹ s with heating by absorption of laser radiation. In addition, the change in the direction of magnetization may take place over a short distance, of the order of 200 nm for the MnAs/GaAs matrix.

1. A method of modifying the direction of magnetization of an upper layer having a ferromagnetic material, said method comprising the steps of:
a) placing the upper layer above a lower layer that is not magnetically coupled with the upper layer, the lower layer comprising a material suitable for acting or not acting, depending on whether the temperature of said material is greater than or less than a threshold value, to produce a radiated magnetic field suitable for modifying the direction of magnetization of the upper layer, the magnetic field radiated by the material of the lower layer being greater than the coercive field of the ferromagnetic material of the upper layer;
and in that the method comprises:
b) a step including causing the temperature of the lower layer to pass from a first value in which the directions of magnetization of the upper layer and of the lower layer are in a stable relative configuration and in which the material of the lower layer does not produce a radiated magnetic field, to a second value in which the material of the lower layer produces a radiated magnetic field suitable for modifying the direction of magnetization of the upper layer in irreversible manner; and
c) a step including causing the temperature of the lower layer to pass from the second value to a third value in which the material of the lower layer does not produce a radiated magnetic field;
the temperature variation steps and c) being performed without applying an external magnetic field.

2. A method according to claim 1, wherein the material of the lower layer is capable of producing a radiated magnetic field suitable for modifying the direction of magnetization of the upper layer when the temperature of said material is higher than a threshold value.

3. A method according to claim 1, wherein, depending on whether the temperature of the material of the lower layer is lower than or higher than a threshold value, the lower layer presents a uniform structure that is entirely ferromagnetic or a non-uniform structure comprising an alternation of zones that are ferromagnetic and non-ferromagnetic.

4. A method according to claim 3, wherein the material of the lower layer presents a uniform structure when the temperature of the material is lower than a threshold temperature, and in that it presents a non-uniform structure when the temperature of the material is higher than a threshold temperature.

5. A method according to claim 4, wherein the lower layer is a layer of MnAs formed by epitaxy on a GaAs substrate.

6. A method according to claim 3, wherein the non-uniform structure of the lower layer is obtained by implanting ions in the lower layer.

7. A method according to claim 6, wherein the lower layer is a layer selected from the group consisting of FePd, FeNi, NiMn, FeGa, or FePt alloy.

8. A method according to claim 1, wherein the upper layer is a layer selected from the group consisting of Fe, Ni, Co, or of a ferromagnetic alloy including at least one of those elements.

9. A method according to claim 1, wherein a layer of non-ferromagnetic material is arranged between the lower layer and the upper layer.
